(19) United States
(12) Patent Application Publication
(10) Pub. No.: US 2019/0126568 A1
(43) Pub. Date: May 2, 2019

(54) METHOD FOR MAKING A CHARGE AIR HOSE

(71) Applicant: CONTITECH MGW GMBH, Hannoversch Münden (DE)

(72) Inventors: Axel Bornemann, Katlenburg-Lindau (DE); Jens Juenemann, Suterode (DE); Martin Hoeer, Gehrden (DE)

(21) Appl. No.: 16/098,799

(22) PCT Filed: Feb. 27, 2017
(86) PCT No.: PCT/EP2017/054434

§ 371 Date: Nov. 2, 2018

(30) Foreign Application Priority Data
May 11, 2016 (DE) 102016208116.0

(51) Int. Cl. B29C 70/34

(52) U.S. Cl. CPC B29C 70/345; B29L 2023/005

(57) ABSTRACT

The disclosure relates to a method of producing a charge air hose or pipe from plastic. It is an object of the disclosure to provide a method of producing charge air hoses, via which charge air hoses are producible from continuous fiber-reinforced plastics with uniform wall thickness and an inner outline of high precision. This method gives rise to a charge air pipe having a reinforced thermoplastic matrix as wall. Advantages of a thermoplastic matrix are a high degree of awareness for processing purposes and the option of bonding additional connecting and functional elements, for example holders, made of thermoplastic to the component via methods including welding methods.

### CROSS REFERENCE TO RELATED APPLICATIONS

This application is the national stage of PCT/EP2017/054434, filed Feb. 27, 2017, designating the United States and claiming priority from German patent application no. 10 2016 208 116.0, filed May 11, 2016, the entire contents of which are incorporated herein by reference.

### FIELD OF THE INVENTION

The disclosure relates to a method of producing a charge air hose or pipe from plastic.

### BACKGROUND OF THE INVENTION

For assurance of the functionality of the charge air system for internal combustion engines, rigid and flexible conduits are used for connection between turbocharger, resonator, charge air cooler and engine inlet. Owing to compact engine configuration, these components generally have a very complex geometry, that is, including one or more angles of curvature.

The geometric demands (internal tubular diameter) result from the amount of air to be transported, and the length of the hoses from the construction details of the engine space. Taking account of the thermomechanical and chemical stresses, the rigid conduits, according to the current state of the art, are produced primarily from thermoplastics with or without fiber reinforcement by the blow-molding method and injection-molding method. Typical materials which are used for the components are commodity thermoplastics, for example, polypropylene (PP), engineering thermoplastics, for example, polyamide (PA), high-temperature thermoplastics, for example, polyphenylene sulfide (PPS), or thermoplastic elastomers (TPE).

DE 10 2014 110 747 discloses, for example, a hose that has been blow-molded without reinforcing fibers.

A disadvantage of the blow-molding method are a high proportion of waste for technological reasons, an undefined surface in the interior of the hose and a nonuniform wall thickness over the component cross section, primarily in the region of angles of curvature. In regions of radii, the result is an accumulation of material on the inner diameter and a reduction in wall thickness on the outer diameter. In order to meet the thermomechanical demands, a minimum wall thickness has to be assured in all regions of the charge air hose, the effect of which is that a very high material input is needed and hence the wall thickness in straight sections of the charge air hose, for process-related reasons, is partly above the required minimum wall thickness.

In order to avoid the disadvantages of blow-molding technology, there are also known charge air hoses wherein the wall consists of fiber-reinforced plastics. DE 10 2012 208 363 proposes a charge air hose having a preform as extrusion component. However, the reinforcement materials are only applicable after the production of the preform.

This solution entails a multistage production process. Moreover, in the extrusion, the selection of the fibers available is limited, especially in terms of fiber length.

### SUMMARY OF THE INVENTION

It is an object of the invention to provide a method of producing charge air hoses, via which charge air hoses are producible from continuous fiber-reinforced plastics with uniform wall thickness and an inner outline of high precision.

This object can, for example, be achieved via a method having the following steps:
A) braiding a hose outline on a core using continuous fibers, where at least some of the continuous fibers include thermoplastically formable material,
B) laying the fiber braid together with the core into a mold,
C) heating the mold such that the thermoplastic continuous fibers melt,
D) cooling the mold with application of a pressure in the mold,
E) removing the component from the mold and removing the core.

This method gives rise to a charge air hose having a reinforced thermoplastic matrix as wall. Advantages of a thermoplastic matrix are a high degree of awareness for processing purposes and the option of bonding additional connecting and functional elements, for example holders, made of thermoplastic to the component via methods including welding to methods.

In an embodiment of the invention, the core is compressible.

The compressibility of the core has the advantage that, even in the case of hose forms that are relatively complex within certain limits, the core is still removable from the ready-hardened hose.

In an embodiment of the invention, the braiding is effected via an automatic circular braiding machine.

The use of automated machines makes the production of the hoses less costly.

In an embodiment of the invention, the continuous fibers take the form of a hybrid yarn.

In an embodiment of the invention, the hybrid yarn includes inorganic reinforcing fibers and thermoplastic fibers.

In an embodiment of the invention, the inorganic reinforcing fibers take the form of glass fibers. In an embodiment of the invention, the hybrid yarn includes organic reinforcing fibers and thermoplastic fibers.

In an embodiment of the invention, the organic reinforcing fibers take the form of carbon fibers.

In an embodiment of the invention, the thermoplastic fibers take the form of polypropylene fibers.

In an embodiment of the invention, the thermoplastic fibers take the form of polyamide fibers.

In an embodiment of the invention, the thermoplastic fibers take the form of polyester fibers.

By virtue of the option of using a great variety of fibers for braiding, the method is adaptable to a broad spectrum of uses.

### BRIEF DESCRIPTION OF THE DRAWING

The invention will now be described with reference to the single FIGURE of the drawing (FIG. 1) which shows the steps B) to D) of the method of the invention in schematic form.

FIG. 1 shows the steps B) to D) of the method of the invention in schematic form. A braid 2 made of continuous reinforcing fibers 3 and thermoplastic fibers 4 is braided onto a compressible core 1, in the form here of an inflatable hose. For simplification of the representation, the thermoplastic fibers 4 are shown in corrugated form here. This does not mean that the thermoplastic fibers 4 are actually corrugated in methods of the invention. The corrugated representation serves merely for better distinguishability in the drawing.

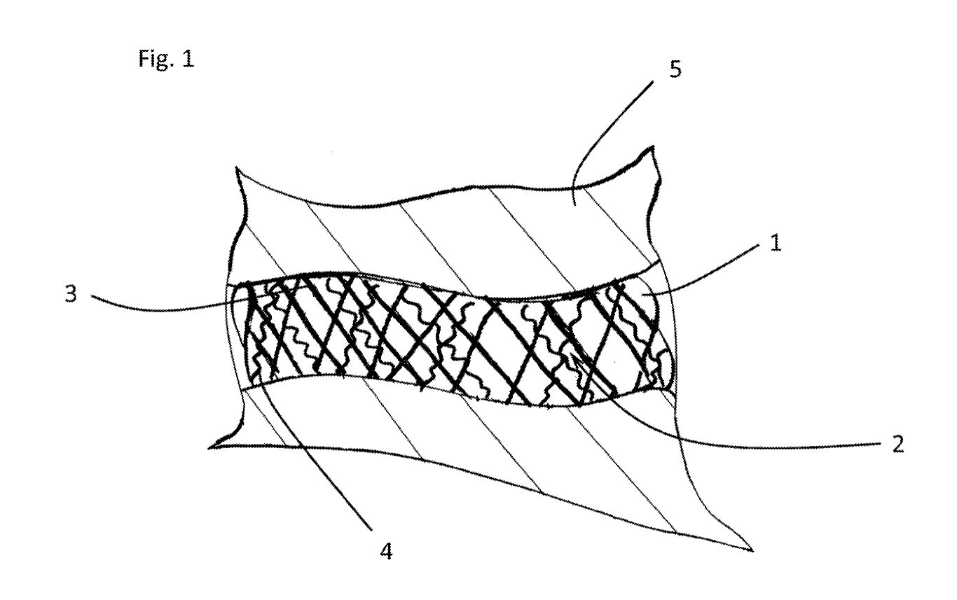

The core 1 with the braid 2 is inserted into a longitudinally separable mold 5. The mold 5 is heatable by means known per se that are not shown here. After the mold 5 has been closed, it is heated in such a way that the thermoplastic fibers 4 are made to melt. The molten plastic now forms a matrix into which the reinforcing fibers 3 are embedded. By application of controlled pressure in the mold 5 and controlled cooling of the mold 5, the matrix is made to solidify. The solidified matrix is not shown any further here. The ready-solidified hose made from solidified plastic matrix and reinforcing fibers 3 is removed after the mold 5 has been opened.

The inflatable core 1 can now be emptied and removed from the finished, through from the solidified hose.

It is understood that the foregoing description is that of the preferred embodiments of the invention and that various changes and modifications may be made thereto without to departing from the spirit and scope of the invention as defined in the appended claims.

### REFERENCE NUMERALS

### (Part of the Description)

1 compressible core
2 braid
3 continuous reinforcing fibers
4 thermoplastic fibers
5 longitudinally separable mold

1-11. (canceled)

12. A method for making a charge air hose from plastic, the method comprising the steps:
braiding a hose outline on a core using continuous fibers, wherein at least some of the continuous fibers are thermoplastic fibers which are made of thermoplastically formable material;
laying the fiber braid together with the core into a heatable mold;
heating the mold such that the thermoplastic fibers melt;
cooling the mold with application of a pressure in the mold; and,
removing a resulting component from the form and removing the core.

13. The method of claim 12, wherein the core is compressible.

14. The method of claim 12, wherein said braiding is effected via an automatic circular braiding machine.

15. The method of claim 12, wherein the continuous fibers are in the form of hybrid yarn.

16. The method of claim 15, wherein the hybrid yarn includes inorganic reinforcing fibers and thermoplastic fibers.

17. The method of claim 16, wherein the inorganic reinforcing fibers are glass fibers.

18. The method of claim 15, wherein the hybrid yarn includes organic reinforcing fibers and thermoplastic fibers.

19. The method of claim 18, wherein said organic reinforcing fibers are carbon fibers.

20. The method of claim 16, wherein the thermoplastic fibers are polypropylene fibers.

21. The method of claim 16, wherein the thermoplastic fibers are polyamide fibers.

22. The method of claim 16, wherein the thermoplastic fibers are polyester fibers.
